(19) United States
(12) Patent Application Publication
(10) Pub. No.: US 2023/0240257 A1
(43) Pub. Date: Aug. 3, 2023

(54) SMART PET FEEDER

(71) Applicant: Huizhou du du Pet Products Co. LTD, Huizhou (CN)

(72) Inventors: Xianqiang Zhang, Xiangtan (CN); Zuohua Xiong, Huizhou (CN)

(21) Appl. No.: 18/131,888

(22) Filed: Apr. 7, 2023

(51) Int. Cl. A01K 5/01

(52) U.S. Cl. CPC A01K 5/0135

(57) ABSTRACT

The present disclosure discloses a smart pet feeder, motor drives the rotating mechanism to rotate, and the rotating mechanism quantitatively pushes the pet food in the support into a sliding chute, and the pet food falls into the food bowl through the sliding chute, which effectively achieves smart quantitative feeding of pets in either an automatic manner or a manual manner.

### TECHNICAL FIELD

The present disclosure relates to the technical field of pet supplies, specifically to a smart pet feeder.

### BACKGROUND

With the improvement of living standards, many families have pets, such as kittens and puppies. When owners feed their pets, they usually place pet food in pet bowls to facilitate pet feeding. However, pets often cannot eat all food in the pet bowls. As containers, most pet bowls are open. Pet food exposed to the air will easily attract flies and affect the quality of food. In this case, the owner can place a lid on the pet bowl to preserve the pet food. However, the owner needs to remove the lid when the pet wants to eat food again, and the owner also needs to remove the lid first to place food. The entire process is very cumbersome and time-consuming for the owner. Therefore, a smart pet feeder is provided to solve the problem that the pet feeder in the prior art is not smart enough.

### SUMMARY

One objective of the present disclosure is to provide a smart pet feeder, to solve the problem that the pet feeder in the prior art is not smart enough.

A smart pet feeder of the present disclosure can be implemented by the following technical solutions:

The present disclosure provides a smart pet feeder, including a base assembly, which is a control main body; a food bucket assembly, which is detachably arranged above the base assembly, wherein pet food is accommodated in the food bucket assembly; a rotating assembly, which is movably arranged in a cavity encircled by the base assembly and the food bucket assembly, wherein the rotating assembly includes a support, a motor, a drive member, a rotating mechanism and a sensor; the support is fixed on the base assembly, and is used for accommodating pet food that falls off from the food bucket assembly; the motor is arranged in the base assembly in a penetrating manner, and provides rotating power to the rotating mechanism; the drive member is arranged on a rotating shaft of the motor and penetrates through the support; the drive member drives the rotating mechanism to rotate; the rotating mechanism is movably arranged in the support and is connected with the drive member; the rotating mechanism transfers the pet food in the support to the base assembly; and the sensor is fixedly arranged on a side edge of the rotating mechanism, and monitors a rotating angle of the rotating mechanism in real time; a lid assembly, which is movably arranged above the food bucket assembly, wherein pet food is added to the food bucket assembly through the lid assembly; and a food bowl, which is arranged on a side edge of the base assembly, wherein the pet food in the food bucket assembly falls into the food bowl through the rotating assembly.

Preferably, the base assembly includes a main shell, a cover plate, a circuit board, a button display mechanism, a horn and a power supply cable; the main shell is a hollow cavity; the cover plate is arranged above the main shell to form a closed hollow cavity; the circuit board is fixedly arranged in the main shell, and is used for receiving an instruction of the button display mechanism and controlling the horn and the rotating assembly to work; the button display mechanism is arranged on the circuit board and penetrates through the main shell; function setting and displaying are performed by the button display mechanism; the horn is fixedly arranged on a side edge of the main shell and is used for achieving voice broadcasting; the power supply cable is electrically connected to the circuit board through the main shell; and power is supplied to the circuit board, the button display mechanism and the horn separately by using the power supply cable.

Preferably, the base assembly further includes a dry battery pack detachably connected in the main shell; and the dry battery pack supplies power to the circuit board, the button display mechanism and the horn separately.

Preferably, the base assembly further includes a microphone which is arranged in the main shell and is electrically connected to the circuit board; and the microphone is used for achieving a recording operation.

Preferably, the cover plate is provided with a sliding chute at a position corresponding to the food bowl; the sliding chute has a certain obliquity; and the pet food slides into the food bowl through the sliding chute.

Preferably, pressing mechanisms are symmetrically movably arranged on two sides of the cover plate; and the two pressing mechanisms are simultaneously pressed to make the food bucket assembly detachably connected above the base assembly.

Preferably, the two pressing mechanisms are symmetrically movably arranged on two sides of the main shell; and the two pressing mechanisms are simultaneously pressed to make the food bucket assembly detachably connected above the base assembly.

Preferably, a wireless communication module is arranged on the circuit board, and the circuit board can be wirelessly connected to an application program or a mini program on an electronic terminal by using the wireless communication module.

Preferably, the wireless connection module uses one or more of a Bluetooth wireless communication module, a WIFI wireless communication module, a 4G wireless communication module and a 5G wireless communication module.

Preferably, the button display mechanism includes a plurality of buttons and a display screen; the plurality of buttons are separately used for controlling running of the feeder; and the display screen is used for displaying all types of data.

Preferably, the food bucket assembly includes a food bucket main body, a fastening slot, two first through holes and a window; the food bucket main body is of a hollow barrel-shaped structure, which accommodates the pet food; the fastening slot is formed in an inner wall of the food bucket main body and cooperates with the lid assembly, so that the lid assembly is detachably connected above the food bucket assembly; and the two first through holes are symmetrically arranged on a side edge of the food bucket main body respectively in a penetrating manner, and separately cooperate with the corresponding pressing mechanisms to detachably connect the food bucket assembly to the base assembly.

Preferably, a partition plate is arranged in the food bucket main body; and the partition plate has a certain obliquity, so that the pet food can slide off to a bottom of the partition plate.

Preferably, a food outlet is formed in the partition plate in a penetrating manner; and the pet food in the food bucket main body falls into the support through the food outlet.

Preferably, a food outlet hole and a drive member hole are formed in a bottom of the support in a penetrating manner; a position of the food outlet hole corresponds to a position of the sliding chute; the rotating mechanism pushes the pet food in the support into the sliding chute through the food outlet hole; the drive member hole is formed in a center of the bottom of the support in a penetrating manner; and the drive member penetrates through the bottom of the support through the drive member hole.

Preferably, the rotating mechanism includes a rotating member, a food turntable and stirring fan blades; the rotating member is movably arranged in the support and is connected with the drive member; the food turntable is fixedly arranged at a periphery of the rotating member and is movably arranged in the support; the food turntable pushes the pet food in the support into the sliding chute through the food outlet hole; the stirring fan blades are fixedly arranged at an upper end of the rotating member and are movably arranged in the food bucket assembly; and the stirring fan blades stir the pet food in the food bucket assembly.

Preferably, the food turntable includes a turntable shaft and a plurality of stoppers; the turntable shaft is fixedly connected with the rotating member; the plurality of stoppers are fixedly arranged on a side edge of the turntable shaft respectively; and a space is reserved between two adjacent stoppers.

Preferably, the lid assembly includes a lid main body, a drying box and a fastener mechanism; the lid main body is movably arranged above the food bucket assembly, and pet food is added to the food bucket assembly through the lid main body; the drying box is movably connected to a lower surface of the lid main body, and is used for drying the pet food in the food bucket assembly; the fastener mechanism is movably arranged on the lower surface of the lid main body in a penetrating manner and corresponds to a position of the fastening slot; and the fastener mechanism cooperates with the fastening slot to detachably arrange the lid assembly above the food bucket assembly.

Preferably, the fastener mechanism includes a supporting member, a fastener and a pressing member; the supporting member is fixedly arranged on the lower surface of the lid main body, and is used for supporting the fastener and the pressing member; the fastener is movably arranged on the supporting member and is in contact connection with the fastening slot; and the pressing member is connected with the fastener and penetrates through the lid main body.

Compared with the prior art, the smart pet feeder of the present disclosure has the beneficial effects as follows:

According to the smart pet feeder of the present disclosure, an automatic feeding mode or a manual feeding mode is set by using the button display mechanism; the motor is controlled to rotate, and then synchronously drives the rotating mechanism to rotate under a drive effect of the drive member; the rotating mechanism quantitatively pushes the pet food in the support to the position of the food outlet hole, so that the pet food falls into the sliding chute from the food outlet hole, and then falls into the food bowl due to the inclination of the sliding chute, and pets eat the pet food, which effectively achieves smart quantitative feeding of pets in either an automatic manner or a manual manner.

### BRIEF DESCRIPTION OF THE DRAWINGS

In order to explain the technical solutions of the embodiments of the present disclosure more clearly, the following will briefly introduce the accompanying drawings used in the embodiments. It should be understood that the drawings in the following description only illustrate some embodiments of the present disclosure and thus shall not be deemed as limiting the scope. Those of ordinary skill in the art can obtain other related drawings based on these drawings without creative work.

FIG. 1 is a schematic diagram of a three-dimensional structure of a smart pet feeder of the present disclosure;

FIG. 2 is a schematic diagram of a three-dimensional structure of another side of the smart pet feeder of the present disclosure shown in FIG. 1;

FIG. 3 is a schematic diagram of a sectional structure of the smart pet feeder of the present disclosure shown in FIG. 1;

FIG. 4 is a schematic diagram of an exploded structure of the smart pet feeder of the present disclosure shown in FIG. 1, including a base assembly, a rotating assembly, a food bucket assembly and a lid assembly;

FIG. 5 is a schematic diagram of an exploded structure of the base assembly in the smart pet feeder of the present disclosure shown in FIG. 4;

FIG. 6 is a schematic structural diagram of the rotating assembly in the smart pet feeder of the present disclosure shown in FIG. 4;

FIG. 7 is a schematic diagram of an exploded structure of the rotating assembly shown in FIG. 6, including a support and a rotating mechanism;

FIG. 8 is a schematic structural diagram of the support shown in FIG. 7;

FIG. 9 is a schematic diagram of an exploded structure of the rotating mechanism shown in FIG. 7;

FIG. 10 is a schematic structural diagram of the food bucket assembly in the smart pet feeder of the present disclosure shown in FIG. 4; and

FIG. 11 is a schematic diagram of an exploded structure of the lid assembly in the smart pet feeder of the present disclosure shown in FIG. 4.

Reference numerals in the drawings: 10: base assembly; 11: main shell; 111: food pad; 12: cover plate; 121: sliding chute; 122: pressing mechanism; 13: circuit board; 14: button display mechanism; 15: horn; 16: power supply cable; 17: dry battery pack; 20: rotating assembly; 21: support; 211: food outlet hole; 212: drive member hole; 22: limiting block; 23: motor; 24: drive member; 25: rotating mechanism; 251: rotating member; 252: food turntable; 2521: turntable shaft; 2522: stopper; 253: stirring fan blade; 2531: fixing member; 26: sensor; 30: food bucket assembly; 31: food bucket main body; 311: partition plate; 312: food outlet; 32: fastening slot; 33: first through hole; 34: window; 40: lid assembly; 41: lid main body; 411: second through hole; 42: drying box; 43: fastener mechanism; 431: supporting member; 432: fastener; 433; pressing member; and 50: food bowl.

### DETAILED DESCRIPTION OF THE EMBODIMENTS

In order to make the objectives, technical solutions and advantages of the embodiments of the present disclosure clearer, the technical solutions in the embodiments of the present disclosure will be described clearly and completely below in combination with the drawings in the embodiments of the present disclosure. Obviously, the embodiments described herein are part of the embodiments of the present disclosure, not all the embodiments. The components of the embodiments of the present disclosure generally described and shown in the drawings here can be arranged and designed in a variety of different configurations.

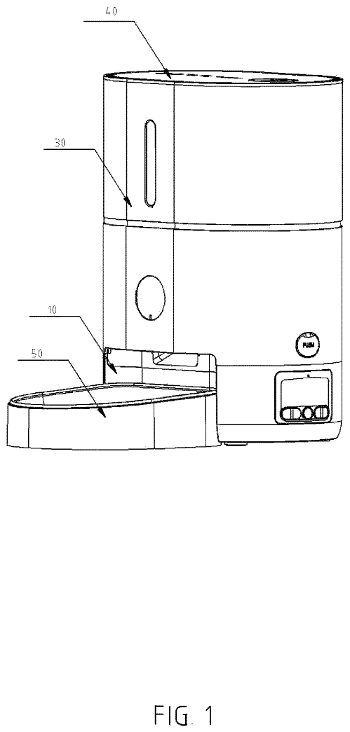

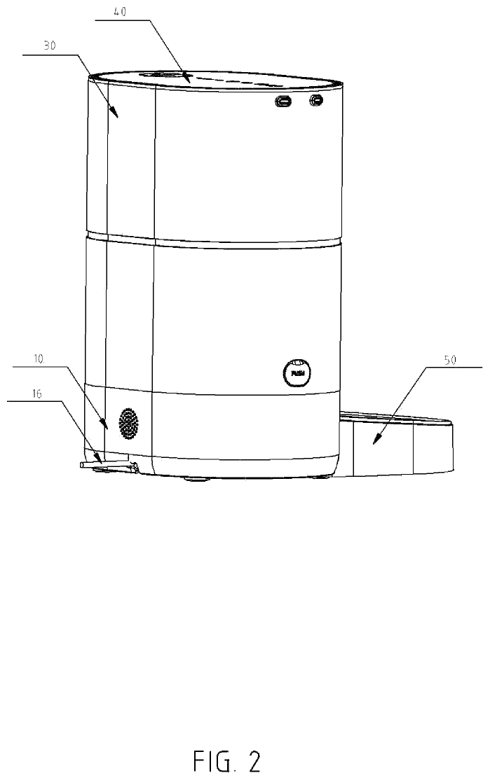

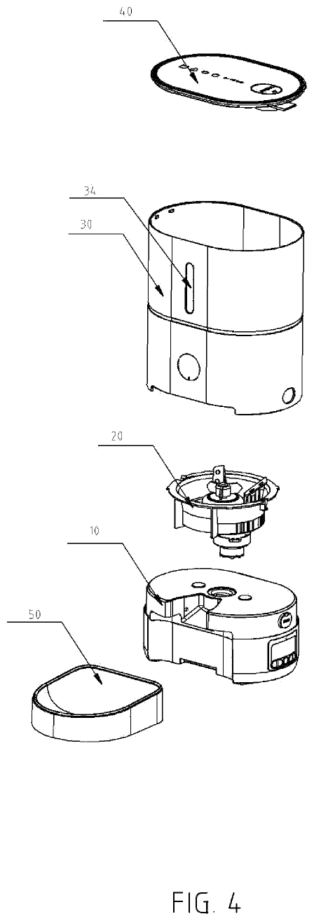

Referring to FIG. 1 to FIG. 4, a smart pet feeder of the present disclosure mainly includes a base assembly 10, a rotating assembly 20, a food bucket assembly 30, a lid assembly 40 and a food bowl 50. The base assembly 10 is a control main body. The food bucket assembly 30 is detachably arranged above the base assembly 10, and pet food is accommodated in the food bucket assembly 30. The rotating assembly 20 is movably arranged in a cavity encircled by the base assembly 10 and the food bucket assembly 30, and controls falling of the pet food in the food bucket assembly 30. The lid assembly 40 is movably arranged above the food bucket assembly 30. Pet food can be added to the food bucket assembly 30 by opening the lid assembly 40, and the pet food can be prevented from being exposed to air to affect the quality of the food. The food bowl 50 is arranged on a side edge of the base assembly 10. The pet food in the food bucket assembly 30 falls into the food bowl 50 under the action of the rotating assembly 20, so that a pet can eat the food.

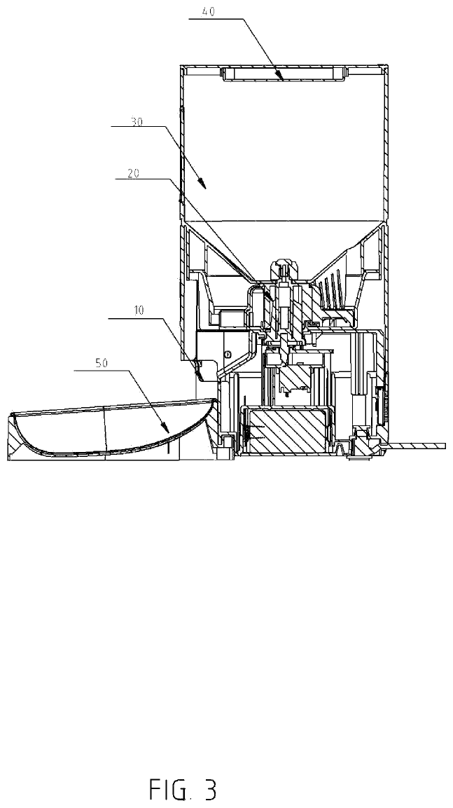

Referring to FIG. 3 to FIG. 5, in this embodiment, the base assembly 10 includes a main shell 11, a cover plate 12, a circuit board 13, a button display mechanism 14, a horn 15, a power supply cable 16 and a dry battery pack 17. The main shell 11 is a hollow cavity. The cover plate 12 is arranged above the main shell 11, and the cover plate 12 and the main shell 11 are fixed by a fastener structure or a screw structure to form a closed hollow cavity. The circuit board 13 is fixedly arranged in the main shell 11, and is used for receiving an instruction of the button display mechanism 14 and controlling the horn 15 and the rotating assembly 20 to work. The button display mechanism 14 is arranged on the circuit board 13 and penetrates through the main shell 11. Function setting and displaying are performed by the button display mechanism 14. The horn 15 is fixedly arranged on a side edge of the main shell 11 and is used for achieving voice broadcasting. The power supply cable 16 is electrically connected to the circuit board 13 through the main shell 11, and power is supplied to the circuit board 13, the button display mechanism 14 and the horn 15 separately by using the power supply cable 16. The dry battery pack 17 is detachably connected in the main shell 11, and can also supply power to the circuit board 13, the button display mechanism 14 and the horn 15 respectively. In other embodiments, the base assembly 10 further includes a microphone which is arranged in the main shell 11 and is electrically connected to the circuit board 13. The microphone is used for achieving a recording operation.

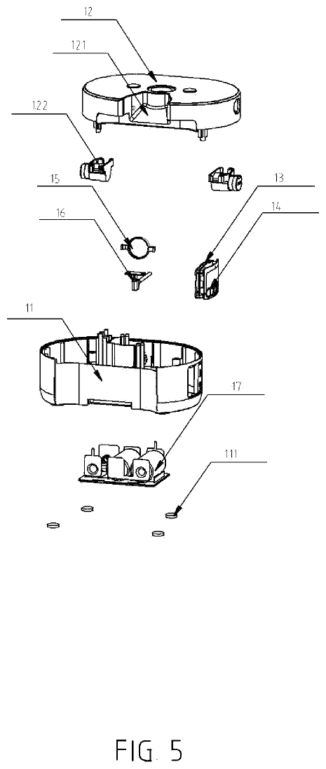

Referring to FIG. 5, a plurality of food pads 111 are arranged below the main shell 11. In this embodiment, four food pads 111 are symmetrically arranged at four corners below the main shell 11 respectively. The cover plate 12 is provided with a sliding chute 121 at a position corresponding to the food bowl 50. The sliding chute 121 has a certain obliquity, which facilitates the pet food to slide into the food bowl 50 arranged below the sliding chute 121. Pressing mechanisms 122 are symmetrically movably arranged on two sides of the cover plate 12. The two pressing mechanisms 122 are simultaneously pressed to make the food bucket assembly 30 detachably connected above the base assembly 10. In other embodiments, the two pressing mechanisms 122 can also be symmetrically movably arranged on two sides of the main shell 11.

Referring to FIG. 5, in this embodiment, the circuit board 13 is electrically connected to the button display mechanism 14, the horn 15, the power supply cable 16, the dry battery pack 17, the rotating assembly 20 and the microphone respectively. A control technology used by the circuit board is the prior art, so that a specific control process of the control technology and a type of the circuit board will not be described in detail here, as long as the specific control process and the type satisfy the present disclosure. A wireless communication module is arranged on the circuit board 13. The circuit board can be wirelessly connected to an application program or a mini program on an electronic terminal, thereby achieving wireless control on the pet feeder. Specifically, the wireless communication module can adopt one or more of a Bluetooth wireless communication module, a WIFI wireless communication module, a 4G wireless communication module and a 5G wireless communication module. In this embodiment, the wireless communication module adopts the Bluetooth wireless communication module and the WIFI wireless communication module. The button display mechanism 14 includes a plurality of buttons and a display screen. The plurality of buttons are separately used for controlling running of the feeder. The display screen is used for displaying all types of data.

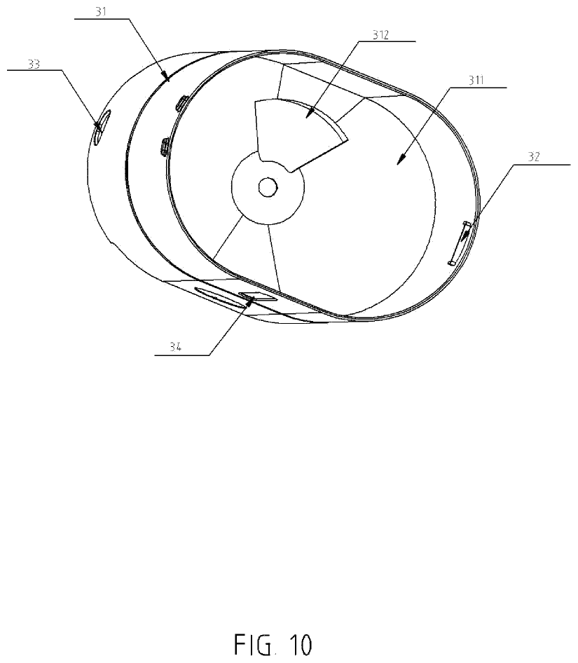

Referring to FIG. 3 and FIG. 10, in this embodiment, the food bucket assembly 30 includes a food bucket main body 31, a fastening slot 32, two first through holes 33 and a window 34. The food bucket main body 31 is of a hollow barrel-shaped structure, which accommodates the pet food. The fastening slot 32 is formed in an inner wall of the food bucket main body 31 and cooperates with the lid assembly 40, so that the lid assembly 40 is detachably connected above the food bucket assembly 30. The two first through holes 33 are symmetrically arranged on a side edge of the food bucket main body 31 respectively in a penetrating manner, and separately cooperate with the corresponding pressing mechanisms 122 to detachably connect the food bucket assembly 30 to the base assembly 10. In this embodiment, a partition plate 311 is arranged in the food bucket main body 31. The partition plate 311 has a certain obliquity, so that the pet food slides off to a bottom of the partition plate 311. A food outlet 312 is formed in the partition plate 311 in a penetrating manner. The pet food in the food bucket main body 31 falls off through the food outlet 312.

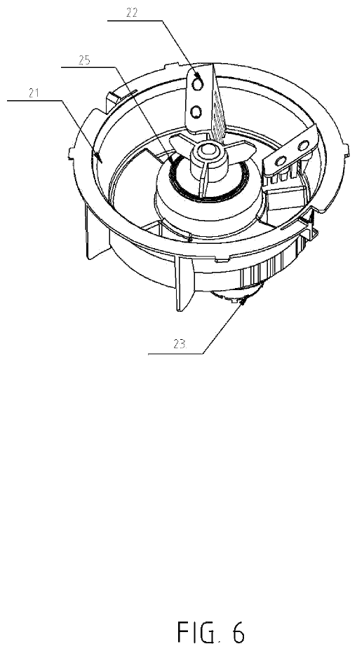

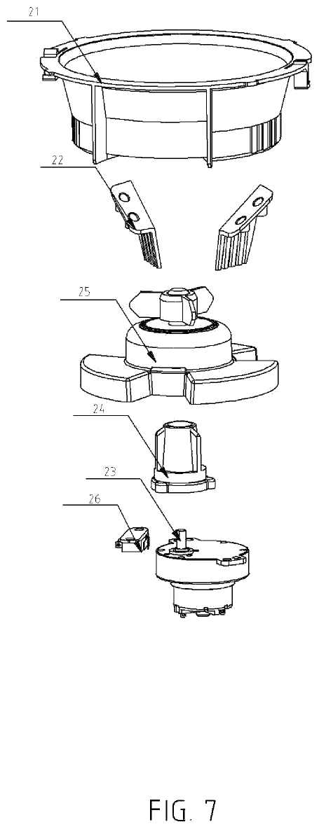

Referring to FIG. 3, FIG. 6 and FIG. 7, in this embodiment, the rotating assembly 20 includes a support 21, two limiting blocks 22, a motor 23, a drive member 24, a rotating mechanism 25 and a sensor 26. The support 21 is of a hollow ring shape and is fixed on the base assembly 10. The pet food in the food bucket assembly 30 can fall into the support 21 through the food outlet 312. The two limiting blocks 22 are symmetrically arranged on a side edge of the food outlet 312 to limit the pet food that falls into the support 21. The motor 23 is arranged in the base assembly 10 in a penetrating manner, and is used for providing rotating power to the rotating mechanism 25. The drive member 24 is arranged on a rotating shaft of the motor 23, penetrates through the support 21, and rotates as the rotating shaft rotates. The rotating mechanism 25 is movably arranged in the support 21, connected with the drive member 24 and driven by the drive member 24 to rotate. Under the action of the rotating mechanism 25, the pet food that falls into the support 21 is transferred into the sliding chute 121, and then falls into the food bowl 50 due to the inclination of the sliding chute 121. The sensor 26 is fixedly arranged on a side edge of the rotating mechanism 25, and monitors a rotating angle of the rotating mechanism 25 in real time, thereby accurately controlling running of the motor 23 and opening or closing a channel by which the pet food falls into the sliding chute 121.

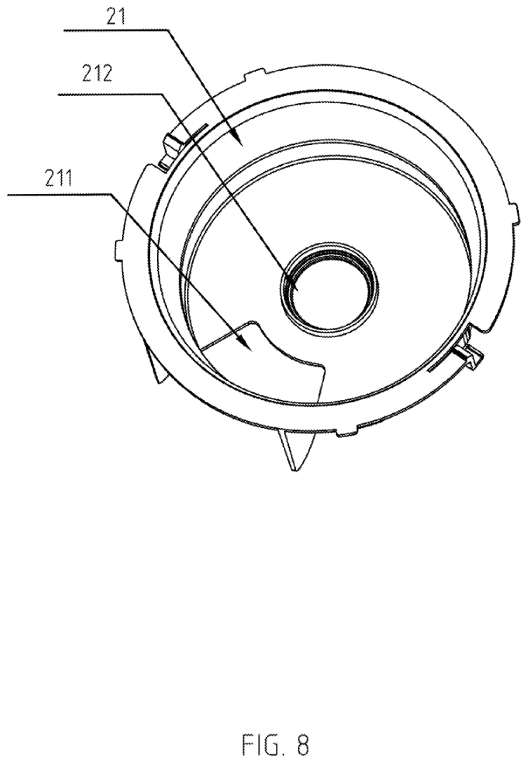

Referring to FIG. 7 and FIG. 8, in this embodiment, a food outlet hole 211 and a drive member hole 212 are formed in a bottom of the support 21 in a penetrating manner. A position of the food outlet hole 211 corresponds to a position of the sliding chute 121. The rotating mechanism 25 pushes the pet food that falls to the support 21 into the sliding chute 121 through the food outlet hole 211, and the pet food falls into the food bowl 50 due to the inclination of the sliding chute 121. The drive member hole 212 is formed in a center of the bottom of the support 21 in a penetrating manner, and the drive member 24 penetrates through the bottom of the support 21 through the drive member hole 212.

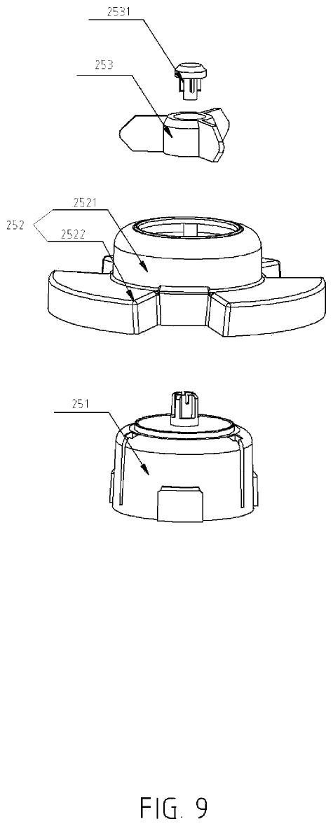

Referring to FIG. 7 and FIG. 9, in this embodiment, the rotating mechanism 25 includes a rotating member 251, a food turntable 252 and stirring fan blades 253. The rotating member 251 is movably arranged in the support 21 and is connected with the drive member 24. The drive member 24 drives the rotating member 251 to rotate. The food turntable 252 is fixedly arranged at a periphery of the rotating member 251, and is movably arranged in the support 21. The food turntable 252 rotates as the rotating member 251 rotates to push the pet food that falls into the support 21 to the position of the food outlet hole 211, so that the pet food falls into the sliding chute 121 from the food outlet hole 211, and then falls into the food bowl 50 due to the inclination of the sliding chute 121. The stirring fan blades 253 are fixedly arranged at an upper end of the rotating member 251 and are movably arranged in the food bucket assembly 30. The stirring fan blades 253 stir the pet food in the food bucket assembly 30, so that the pet food in the food bucket assembly 30 can better fall into the support 21 through the food outlet 312.

Referring to FIG. 9, in this embodiment, the food turntable 252 includes a turntable shaft 2521 and a plurality of stoppers 2522. The turntable shaft 2521 is fixedly connected with the rotating member 251, and rotates as the rotating member 251 rotates. The plurality of stoppers 2522 are fixedly arranged on a side edge of the turntable shaft 2521 respectively. A space is reserved between two adjacent stoppers 2522. Since the food turntable 252 rotates, the pet food in the spaces is pushed to the position of the food outlet hole 211, and is quantitatively pushed through the spaces. Therefore, the pet food falls into the sliding chute 121 from the food outlet hole 211. In this embodiment, the stirring fan blades 253 are fixed at an upper end of the rotating member 251 through a fixing member 2531. Specifically, the fixing member 2531 adopts a fastening screw.

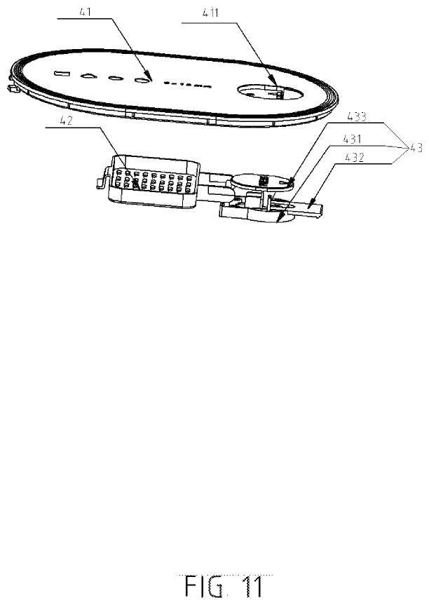

Referring to FIG. 3 and FIG. 11, in this embodiment, the lid assembly 40 includes a lid main body 41, a drying box 42 and a fastener mechanism 43. The lid main body 41 is movably arranged above the food bucket assembly 30, and pet food is added to the food bucket assembly 30 through the lid main body 41. The drying box 42, which accommodates a dryer, is movably connected to a lower surface of the lid main body 41, and is used for drying the pet food in the food bucket assembly 30 under an effect of the dryer and preventing the pet food from getting wet. The fastener mechanism 43 is movably arranged on the lower surface of the lid main body 41 in a penetrating manner and corresponds to a position of the fastening slot 32. The fastener mechanism 43 cooperates with the fastening slot 32 to detachably arrange the lid assembly 40 above the food bucket assembly 30.

Referring to FIG. 11, in this embodiment, the fastener mechanism 43 includes a supporting member 431, a fastener 432 and a pressing member 433. The supporting member 431 is fixedly arranged on the lower surface of the lid main body 41, and is used for supporting the fastener 432 and the pressing member 433. The fastener 432 is movably arranged on the supporting member 431 and can be in contact connection with the fastening slot 32. When the fastener 432 is connected with the fastening slot 32, the lid assembly 40 is fixedly arranged above the food bucket assembly 30. The pressing member 433 is connected with the fastener 432 and penetrates through the lid main body 41. When an external force is applied to the pressing member 433, the pressing member 433 moves down to drive the fastener 432 to move down and be separated from the fastening slot 32, so that the lid assembly 40 can move relative to the food bucket assembly 30.

Referring to FIG. 1 to FIG. 4, in this embodiment, the food bowl 50 is detachably connected to a side edge of the base assembly 10. In this design, it is convenient for storage and transportation, and it is also convenient to clean the food bowl 50.

The technical features of the embodiments described above can be arbitrarily combined. In order to make the description concise, all possible combinations of various technical features in the above embodiments are not completely described. However, the combinations of these technical features should be considered as the scope described in this specification as long as there is no contradiction in them.

The above-mentioned embodiments only express several implementation modes of the present disclosure, and their descriptions are more specific and detailed, but they cannot be understood as limiting the patent scope of the present disclosure. It should be noted that those of ordinary skill in the art can further make various transformations and improvements without departing from the concept of the present disclosure, and these transformations and improvements all fall within the protection scope of the present disclosure. Therefore, the protection scope of the patent of the present disclosure shall be subject to the appended claims.

What is claimed is:

1. A smart pet feeder, comprising a base assembly, which is a control main body;
a food bucket assembly, which is detachably arranged above the base assembly, wherein pet food is accommodated in the food bucket assembly;
a rotating assembly, which is movably arranged in a cavity encircled by the base assembly and the food bucket assembly, wherein the rotating assembly comprises a support, a motor, a drive member, a rotating mechanism and a sensor; the support is fixed on the base assembly, and is used for accommodating pet food that falls off from the food bucket assembly; the motor is arranged in the base assembly in a penetrating manner, and provides rotating power to the rotating mechanism; the drive member is arranged on a rotating shaft of the motor and penetrates through the support; the drive member drives the rotating mechanism to rotate; the rotating mechanism is movably arranged in the support and is connected with the drive member; the rotating mechanism transfers the pet food in the support to the base assembly; and the sensor is fixedly arranged on a side edge of the rotating mechanism, and monitors a rotating angle of the rotating mechanism in real time;
a lid assembly, which is movably arranged above the food bucket assembly, wherein pet food is added to the food bucket assembly through the lid assembly; and
a food bowl, which is arranged on a side edge of the base assembly, wherein the pet food in the food bucket assembly falls into the food bowl through the rotating assembly.

2. The smart pet feeder according to claim 1, wherein the base assembly comprises a main shell, a cover plate, a circuit board, a button display mechanism, a horn and a power supply cable; the main shell is a hollow cavity; the cover plate is arranged above the main shell to form a closed hollow cavity; the circuit board is fixedly arranged in the main shell, and is used for receiving an instruction of the button display mechanism and controlling the horn and the rotating assembly to work; the button display mechanism is arranged on the circuit board and penetrates through the main shell; function setting and displaying are performed by the button display mechanism; the horn is fixedly arranged on a side edge of the main shell and is used for achieving voice broadcasting; the power supply cable is electrically connected to the circuit board through the main shell; and power to the circuit board, the button display mechanism and the horn separately by using the power supply cable.

3. The smart pet feeder according to claim 2, wherein the base assembly further comprises a dry battery pack detachably connected in the main shell; and the dry battery pack supplies power to the circuit board, the button display mechanism and the horn separately.

4. The smart pet feeder according to claim 2, wherein the base assembly further comprises a microphone which is arranged in the main shell and is electrically connected to the circuit board; and the microphone is used for achieving a recording operation.

5. The smart pet feeder according to claim 2, wherein the cover plate is provided with a sliding chute at a position corresponding to the food bowl; the sliding chute has a certain obliquity; and the pet food slides into the food bowl through the sliding chute.

6. The smart pet feeder according to claim 5, wherein pressing mechanisms are symmetrically movably arranged on two sides of the cover plate; and the two pressing mechanisms are simultaneously pressed to make the food bucket assembly detachably connected above the base assembly.

7. The smart pet feeder according to claim 6, wherein the two pressing mechanisms are symmetrically movably arranged on two sides of the main shell; and the two pressing mechanisms are simultaneously pressed to make the food bucket assembly detachably connected above the base assembly.

8. The smart pet feeder according to claim 2, wherein a wireless communication module is arranged on the circuit board, and the circuit board is wirelessly connected to an application program or a mini program on an electronic terminal by using the wireless communication module.

9. The smart pet feeder according to claim 8, wherein the wireless connection module uses one or more of a Bluetooth wireless communication module, a WIFI wireless communication module, a 4G wireless communication module and a 5G wireless communication module.

10. The smart pet feeder according to claim 2, wherein the button display mechanism comprises a plurality of buttons and a display screen; the plurality of buttons are separately used for controlling running of the feeder; and the display screen is used for displaying all types of data.

11. The smart pet feeder according to claim 6, wherein the food bucket assembly comprises a food bucket main body, a fastening slot, two first through holes and a window;
the food bucket main body is of a hollow barrel-shaped structure, which accommodates the pet food; the fastening slot is formed in an inner wall of the food bucket main body and cooperates with the lid assembly, so that the lid assembly is detachably connected above the food bucket assembly; and the two first through holes are symmetrically arranged on a side edge of the food bucket main body respectively in a penetrating manner, and separately cooperate with the corresponding pressing mechanisms to detachably connect the food bucket assembly to the base assembly.

12. The smart pet feeder according to claim 11, wherein a partition plate is arranged in the food bucket main body; and the partition plate has a certain obliquity, so that the pet food slides off to a bottom of the partition plate.

13. The smart pet feeder according to claim 12, wherein a food outlet is formed in the partition plate in a penetrating manner; and the pet food in the food bucket main body falls into the support through the food outlet.

14. The smart pet feeder according to claim 13, wherein a food outlet hole and a drive member hole are formed in a bottom of the support in a penetrating manner; a position of the food outlet hole corresponds to a position of the sliding chute; the rotating mechanism pushes the pet food in the support into the sliding chute through the food outlet hole; the drive member hole is formed in a center of the bottom of the support in a penetrating manner; and the drive member penetrates through the bottom of the support through the drive member hole.

15. The smart pet feeder according to claim 14, wherein the rotating mechanism comprises a rotating member, a food turntable and stirring fan blades; the rotating member is movably arranged in the support and is connected with the drive member; the food turntable is fixedly arranged at a periphery of the rotating member and is movably arranged in the support; the food turntable pushes the pet food in the support into the sliding chute through the food outlet hole; the stirring fan blades are fixedly arranged at an upper end of the rotating member and are movably arranged in the food bucket assembly; and the stirring fan blades stir the pet food in the food bucket assembly.

16. The smart pet feeder according to claim 15, wherein the food turntable comprises a turntable shaft and a plurality of stoppers; the turntable shaft is fixedly connected with the rotating member; the plurality of stoppers are fixedly arranged on a side edge of the turntable shaft respectively; and a space is reserved between two adjacent stoppers.

17. The smart pet feeder according to claim 1, wherein the lid assembly comprises a lid main body, a drying box and a fastener mechanism; the lid main body is movably arranged above the food bucket assembly, and pet food is added to the food bucket assembly through the lid main body; the drying box is movably connected to a lower surface of the lid main body, and is used for drying the pet food in the food bucket assembly; the fastener mechanism is movably arranged on the lower surface of the lid main body in a penetrating manner and corresponds to a position of the fastening slot; and the fastener mechanism cooperates with the fastening slot to detachably arrange the lid assembly above the food bucket assembly.

18. The smart pet feeder according to claim 17, wherein the fastener mechanism comprises a supporting member, a fastener and a pressing member; the supporting member is fixedly arranged on the lower surface of the lid main body, and is used for supporting the fastener and the pressing member; the fastener is movably arranged on the supporting member and is in contact connection with the fastening slot; and the pressing member is connected with the fastener and penetrates through the lid main body.
